(19) United States
(12) Patent Application Publication
(10) Pub. No.: US 2025/0317266 A1
(43) Pub. Date: Oct. 9, 2025

(54) METHODS AND APPARATUSES FOR SUBBAND FULL DUPLEX (SBFD) OPERATION

(71) Applicant: CABLE TELEVISION LABORATORIES, INC., Louisville, CO (US)

(72) Inventors: Yunjung Yi, Vienna, VA (US); Dorin Gheorghe Viorel, Erie, CO (US)

(21) Appl. No.: 19/172,100

(22) Filed: Apr. 7, 2025

Related U.S. Application Data
(60) Provisional application No. 63/575,494, filed on Apr. 5, 2024.

(51) Int. Cl. H04L 5/14; H04L 5/00; H04W 8/24; H04W 76/27

(52) U.S. Cl. CPC H04L 5/14; H04L 5/0092; H04W 8/24; H04W 76/27

(57) ABSTRACT

Methods, systems, and apparatuses for subband full duplex (SBFD) operation within a time division duplex (TDD) carrier are provided. A base station determines a cell-specific SBFD configuration indicative of one or more SBFD subbands such that one or more SBFD symbols do not overlap with any legacy uplink (UL) symbols as indicated by a TDD downlink (DL)/UL configuration new radio (NR). The base station transmits the cell-specific SBFD configuration to an adjacent base station via Xn signaling for coordinated scheduling. The base station transmits the cell-specific SBFD configuration to a plurality of UEs. The base station schedules one or more SBFD-enabled UEs from the plurality of UEs within the one or more SBFD subbands and performs simultaneous uplink and downlink operations on the one or more SBFD subbands.

### CROSS REFERENCE TO RELATED APPLICATIONS

This application claims the benefit of U.S. provisional application No. 63/575,494 filed Apr. 5, 2024, which is incorporated by reference as if fully set forth.

### BACKGROUND

In 5G new radio (NR), unlike traditional time division duplex (TDD) systems that alternate between uplink (UL) and downlink (DL) transmissions in separate time slots, subband full duplex (SBFD) enables simultaneous UL and DL operations within same TDD carrier by dividing a frequency band into distinct subbands. This approach aims to enhance UL spectral efficiency and reduce latency. However, SBFD may face challenges in coexistence and cross-link interference in co-channel and/or adjacent channel conditions, when co-existing with legacy TDD (LTE or 5G) networks.

### SUMMARY

In one or more implementations, a method performed by a base station is provided. The method includes determining a cell-specific subband full duplex (SBFD) configuration indicative of one or more SBFD subbands in a time division duplex (TDD) carrier. The method includes sending the cell-specific SBFD configuration to an adjacent base station using Xn signaling. The method includes transmitting the cell-specific SBFD configuration to a plurality of user equipments (UEs). The method includes scheduling one or more SBFD enabled UEs of the plurality of UEs in the one or more SBFD subbands. The method includes performing SBFD operation on the one or more SBFD subbands.

In an implementation, performing SBFD operation includes transmitting one or more SBFD symbols to the one or more SBFD enabled UEs over the one or more SBFD subbands.

In an implementation, performing SBFD operation includes receiving one or more SBFD symbols from the one or more SBFD enabled UEs over the one or more SBFD subbands.

In an implementation, the plurality of UEs are in a radio resource control (RRC) connected mode.

In an implementation, one or more legacy signals are not used to indicate a link direction on the one or more SBFD symbols.

In an implementation, the one or more legacy signals include at least one of: a slot format indicator (SFI), or a TDD uplink (UL)/downlink (DL) dedicated configuration.

In an implementation, legacy TDD UL/DL dedicated configuration may override one or more flexible symbols.

In an implementation, the one or more flexible symbols are non-DL and non-UL based on a TDD UL/DL common configuration and non-SBFD based on the cell-specific SBFD configuration.

In an implementation, the one or more SBFD symbols do not overlap a legacy UL symbol.

In an implementation, sending the cell-specific SBFD configuration to the adjacent base station comprises sending a semi-static SBFD time and frequency configuration to the adjacent base station.

In an implementation, the semi-static SBFD time and frequency configuration includes one or more frequency locations of UL subbands.

In one or more implementations, a base station is provided. The base station includes a transceiver and a processor. The transceiver and the processor are configured to determine a cell-specific SBFD configuration indicative of one or more SBFD subbands in a TDD carrier. The transceiver and the processor are configured to send the cell-specific SBFD configuration to an adjacent base station using Xn signaling. The transceiver and the processor are configured to transmit the cell-specific SBFD configuration to a plurality of UEs. The transceiver and the processor are configured to schedule one or more SBFD enabled UEs of the plurality of UEs in the one or more SBFD subbands. The transceiver and the processor are configured to perform SBFD operation on the one or more SBFD subbands.

In an implementation, performing SBFD operation includes transmitting one or more SBFD symbols to the one or more SBFD enabled UEs over the one or more SBFD subbands.

In an implementation, performing SBFD operation includes receiving one or more SBFD symbols from the one or more SBFD enabled UEs over the one or more SBFD subbands.

In an implementation, the plurality of UEs are in a RRC connected mode. In an implementation, one or more legacy signals are not used to indicate

a link direction on the one or more SBFD symbols.

In an implementation, the one or more legacy signals include at least one of a SFI, or a TDD UL/DL dedicated configuration.

In an implementation, the legacy TDD UL/DL dedicated configuration overrides one or more flexible symbols.

In an implementation, the one or more flexible symbols are non-DL and non-UL based on a TDD UL/DL common configuration and non-SBFD based on the cell-specific SBFD configuration.

In an implementation, the one or more SBFD symbols do not overlap a legacy UL symbol.

In an implementation, sending the cell-specific SBFD configuration to the adjacent base station comprises sending a semi-static SBFD time and frequency configuration to the adjacent base station.

In an implementation, the semi-static SBFD time and frequency configuration includes one or more frequency locations of UL subbands.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and 5G core (5GC);

FIG. 4 illustrates an example of a protocol stack for a user plane and a control plane;

FIG. 5 illustrates an example of a variable time domain duplexing (TDD) configuration is shown according to one or more embodiments;

FIG. 6 illustrates an example of one or more challenges to utilize a slot format indicator (SFI) for a subband full duplex (SBFD) link direction indication are illustrated according to one or more embodiments; and

FIG. 7 is a flowchart illustrating an SBFD operation performed by a base station according to one or more embodiments.

### DETAILED DESCRIPTION OF THE PREFERRED EMBODIMENTS

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

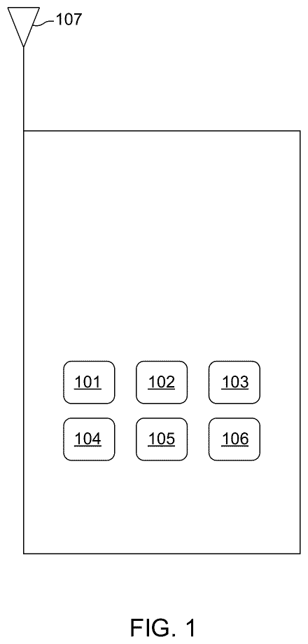

FIG. 1 is an illustration of an example device. In one case, the device may be a User Equipment (UE) suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous (e.g., different timing/spacing for UL or DL).

Different radio access technologies may be used with one or more transceivers (e.g., 802.11, WCDMA, CDMA2000, GSM, LTE, LTE-A, LTE-A Pro, NR etc.).

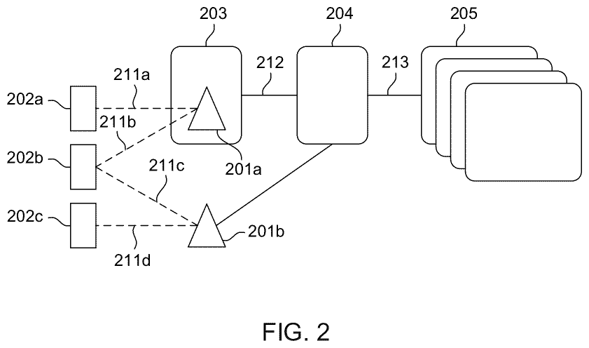

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network 206, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QOS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same RAT as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMF, one or more UPF, one or more Session Management Function (SMF), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

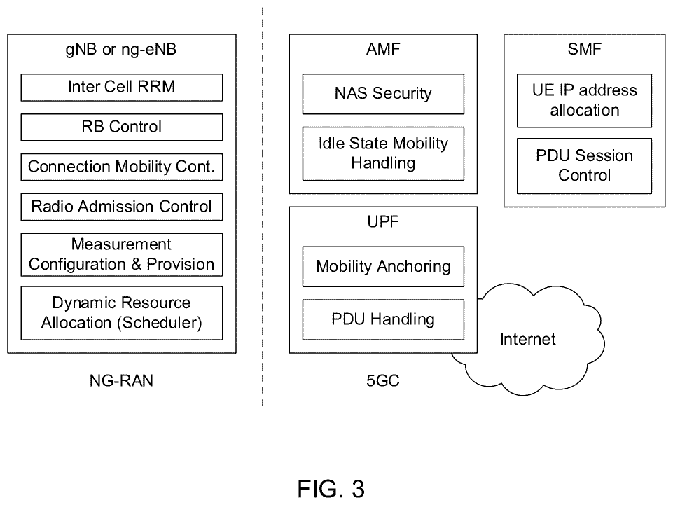

FIG. 3 illustrates an example of a functional split between the NG-RAN and 5GC. The AMF may be connected to one or more gNB the RAN via an N2 interface and may serve as a control node. For example, the AMF may be responsible for authenticating a support of the UE for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

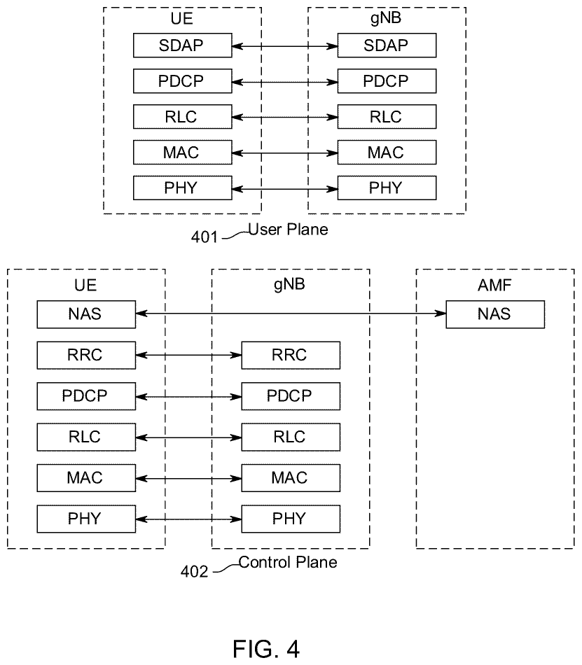

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Various embodiments of the present disclosure provide one or more methods for sub-band full-duplex (SBFD) transmission (TX) and/or reception (RX) operations in wireless communication networks. The wireless communication networks may use a communication protocol and/or a standard, or combination of various communication protocols and/or standards such as but not limited to third generation partnership project (3GPP) long-term evolution (LTE), fifth generation (5G) new radio (NR), and/or 6G etc.

In an implementation, for one or more radio resource control (RRC) connected mode user equipment (UEs), at least cell-specific configuration on time and frequency (working assumption) location of one or more SBFD subbands may be supported within a time division duplexing (TDD) carrier.

In an example, additional support of a UE-specific configuration on time and/or frequency locations of the one or more SBFD subbands may be supported.

In an implementation, for one or more RRC connected mode UEs, one or more SBFD subband time locations may be configured within a period. In an example, at least when only one TDD-UL-DL pattern is configured, the period may be down-selected from one of the following options. In a first option, the period may be the same as a TDD-UL-DL pattern period configured by dl-UL-TransmissionPeriodicity in TDD-UL-DL-ConfigCommon. In a second option, the period may be an integer multiple of the TDD-UL-DL pattern period configured by dl-UL-TransmissionPeriodicity in TDD-UL-DL-ConfigCommon.

In an implementation, an operation when two TDD-UL-DL patterns are configured may be provided. In an example, an SBFD operation is performed on the one or more SBFD subbands. In an implementation, performing the SBFD operation includes transmitting one or more SBFD symbols to one or more SBFD enabled UEs over the one or more SBFD subbands. In an implementation, performing the SBFD operation includes receiving one or more SBFD symbols from the one or more SBFD enabled UEs over the one or more SBFD subbands.

In an implementation, a slot may include the one or more SBFD symbols, one or more non-SBFD symbols and/or a combination of the one or more SBFD symbols and the one or more non-SBFD symbols.

In an example, a maximum number of uplink (UL) subbands for SBFD operation in an SBFD symbol within a TDD carrier is one. The UL subband may be located at one side of the carrier or may be located at the middle part of the carrier. In an example, for semi-static indication of SBFD subband frequency location, the SBFD subband frequency location may be down-selected from the following options. In a first option, one or more frequency locations of the UL subband and one or more DL subbands may be explicitly configured. In an example, one or more guardbands may be implicitly derived as one or more resource blocks (RBs) which may not be within the UL subband and/or the one or more DL subbands. In a second option, the frequency location of the UL subband and a number of RBs for the one or more guardbands may be explicitly configured. The one or more DL subbands may be implicitly derived as the one or more RBs which are not within the UL subband and/or the one or more guardbands.

In an implementation, a slot may include the one or more SBFD symbols and/or the one or more non-SBFD symbols. In an example, for semi-static indication of the SBFD subband time location, when only one TDD-UL-DL pattern is configured, the one or more SBFD symbols may be configured in a consecutive manner within the TDD-UL-DL pattern period. In an example, when two TDD-UL-DL patterns are configured and if the one or more SBFD symbols are configured for only one of the patterns, the one or more SBFD symbols may be configured in a consecutive manner within the TDD-UL-DL pattern period. In an example, when two TDD-UL-DL patterns are configured and if the one or more SBFD symbols are configured for both patterns, the one or more SBFD symbols may be configured in a consecutive manner within each TDD-UL-DL pattern period. The one or more SBFD symbols may be configured in one or more DL and/or flexible symbols configured in TDD-UL-DL-ConfigCommon. The one or more configured SBFD symbols may start from any symbol within a slot and may end in any symbol within a slot. A referenceSubcarrierSpacing in TDD-UL-DL-ConfigCommon may be used as reference sub carrier spacing (SCS).

In an implementation, one or more subband frequency-domain resources may be same across different SBFD symbols within a TDD carrier. A frequency location of cell-specific UL subband, and the one or more DL subbands if explicitly indicated, may be indicated with reference to common resource block (CRB) grid. An RB-level granularity may be supported for semi-static indication of the SBFD subband frequency location. In an example, an example RB-level granularity may be subject to RAN4 guidance on the size of subband and/or guardband.

In an implementation, operation for a reference starting RB and reference SCS may be provided. In an example, one or more UL subband frequency resources within an active UL bandwidth part (BWP) are called UL usable physical resource block (PRBs) and the one or more DL subbands frequency resources within an active DL BWP are called DL usable PRBs.

In an example, for determining UL and/or DL usable PRBs, the UL usable PRBs may be determined as intersection between a cell-specific UL subband and an active UL BWP in the one or more SBFD symbols. The DL usable PRBs may be determined as intersection between one or more cell-specific DL subbands and an active DL BWP in the one or more SBFD symbols.

In an example, the one or more UL and/or DL usable PRBs may be explicitly configured within an active UL and/or DL BWP in the one or more SBFD symbols.

In an implementation, for SBFD-aware UE transmission and/or reception in the one or more SBFD symbols configured in the DL and/or flexible in TDD-UL-DL-ConfigCommon, one or more UL transmissions within the UL usable PRBs may be allowed. In an example, one or more DL receptions within the DL usable PRBs may be allowed. In an example, the one or more UL transmissions outside the UL usable PRBs may not be allowed. In an example, the one or more DL receptions outside the DL usable PRBs may not be allowed. In an example, this restriction may not be applicable for cross link interference (CLI) measurement.

In one or more embodiments, various CLI measurement behaviors for an SBFD-aware UE are provided. In an embodiment, one or more SBFD aware UE behaviors in the one or more SBFD symbols with interaction with legacy TDD slot configuration indications via TDD-UL-DL-ConfigDedicated and SFI in DCI format 2_0 are provided. In an example, DCI format 2_0 may not be used to revert SBFD symbol to non-SBFD symbol.

In an implementation, for SBFD-aware UE transmission and reception in an SBFD symbol, following options may be used to determine link direction, i.e. whether to transmit or to receive in the SBFD symbol. In a first option, UE may determine a link direction based on configured and/or scheduled transmissions and/or receptions and/or collision handling, for example. In a second option, the link direction may be indicated by a base station (e.g., a gNB) explicitly. In an example, other options may be used.

In an implementation, for one or more SBFD-aware UEs, one or more collisions between DL reception in the one or more DL subbands and a UL transmission in the UL subband in a SBFD symbol may be addressed and/or alleviated with proper scheduling. The following cases of potential collisions, if link direction indication is not supported or provided, may be further studied to see if any change to the current specs is necessary. In a first case, dynamically scheduled DL reception and semi-statically configured UL transmission may be studied and/or compared, for e.g., dynamic physical downlink shared channel (PDSCH) and/or channel state information reference signal (CSI-RS) may collide with configured sounding reference signal (SRS), physical uplink control channel (PUCCH), and/or configured grant (CG) PUSCH. In a second case, semi-statically configured DL reception and dynamically scheduled UL transmission may be studied and/or compared, for e.g., physical downlink control channel (PDCCH) and/or semi-persistent scheduling (SPS) PDSCH may collide with dynamic PUSCH and/or PUCCH. In a third case, semi-statically configured DL reception and semi-statically configured UL transmission may be studied and/or compared. In a fourth case, dynamically scheduled DL reception and dynamic scheduled UL transmission may be studied and/or compared. In a fifth case, SSB and dynamically scheduled or configured UL transmission may be studied, for e.g., PUSCH, PUCCH, PRACH, SRS. In a sixth case, dynamic or semi-static DL and valid RO may be studied and/or compared.

In an example, in addition to collision between the UL transmission and the DL reception in the one or more same SBFD symbols, collision between UL transmission and DL reception in different symbols due to lack of sufficient transition time between TX and/or RX at UE side may also be included.

In one or more embodiments, one or more methods address the SBFD aware UE behavior with legacy TDD slot configuration indications via TDD-UL-DL-ConfigDedicated and slot format indicator (SFI) in downlink control information (DCI) format 2_0 in consideration of SBFD work item description (WID) objectives, notes, and/or assumptions etc.

In an example, fair coexistence and cross-link interferences in co-channel and/or adjacent channels based on the various assumptions is addressed. In an example, one UL subband may be used for SBFD operation in an SBFD symbol (excluding legacy UL symbol and/or slot) within a TDD carrier. In an example, one or more mechanisms for SBFD operation may also consider the adjacent channel coexistence between two operators.

In an example, to minimize impact on base station to base station (BS-to-BS) interference introduced by the SBFD operation, an SBFD operation on one or more legacy UL symbols where a legacy UL symbol at least includes symbols intended to be used as uplink by one or more base stations in co-channel and/or adjacent channel may be prevented.

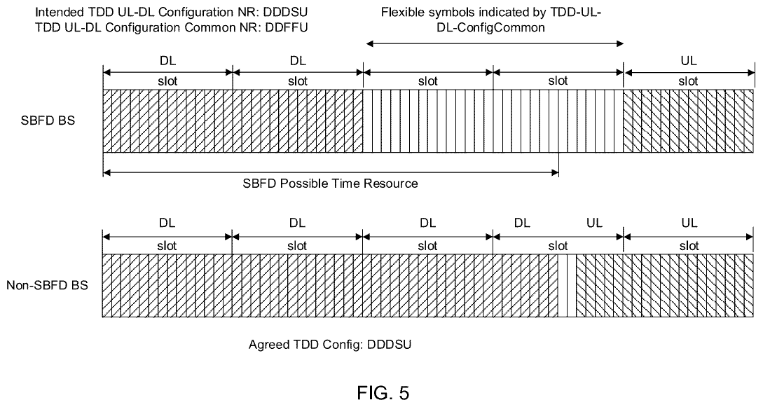

Referring now to FIG. 5, an example of an agreed and/or aligned TDD configuration is shown according to one or more embodiments. In an embodiment, the TDD configuration is [DDDSU], where S has 7 DL symbols, 2 guard symbols and 5 UL symbols, as shown in FIG. 5.

An SBFD base station may configure a cell-specific TDD configuration as DDFFU. In this example, the SBFD base station may exchange DDDSU as an intended DL/UL configuration via Xn signaling (i.e., intended TDD DL-UL configuration NR under served cell information NR) while indicating DDFFU as a cell common DL/UL configuration via Xn signaling (i.e., TDD UL-DL configuration common NR under served cell information NR) with its neighboring base stations. As intended TDD DL-UL configuration NR is to address cross-link-interference among base stations, the SBFD operation of the SBFD base station may be limited to one or more symbols overlapping with non-UL symbols according to the intended TDD DL-UL configuration NR (user served cell information NR via Xn signaling). In other words, the SBFD base station may indicate 3^{rd} slot as DL and/or a first set of SBFD symbols and first 7 symbols of 4^{th} slot as DL and/or a second set of SBFD symbols. The SBFD base station may perform SBFD operation on 1^{st}, 2^{nd}, 3^{rd}, and first 7 symbols of 4^{th} slot, and may be prohibited to operate SBFD on second 7 symbols of 4^{th} slot and 5^{th} slot. Based on the SBFD operation in non-legacy UL symbols, the SBFD base station may indicate a cell-specific SBFD configuration where indicated SBFD symbols do not overlap with the legacy UL symbols (e.g., a UL resource in intended DL-UL configuration, and second 7 symbols of 4^{th} slot and 5^{th} slot).

In an example, the SBFD symbol indicated by a cell-specific configuration on time and frequency location of SBFD subbands may not overlap with the legacy UL symbols indicated by intended TDD DL-UL configuration NR (e.g., intended TDD UL/DL configuration).

In an example, for fair coexistence and to agree cross-link interference, Xn signaling of cell specific SBFD configuration may be considered. For example, CLI handling of coordinated scheduling e.g., information exchange of semi-static SBFD time and frequency configuration among neighboring base stations in co-channel and/or adjacent channels may be considered.

In an embodiment, for cross link interference and fair coexistence, coordinated scheduling mechanism of information exchange, via Xn interface, of semi-static SBFD time/frequency configuration among neighboring base stations in co-channel and/or adjacent channel may be supported.

In an example, UE-specific SBFD configuration may be used, by considering impact on cross link interference such that it may not introduce additional SBFD symbols and additional UL resource beyond cell-specific SBFD symbols.

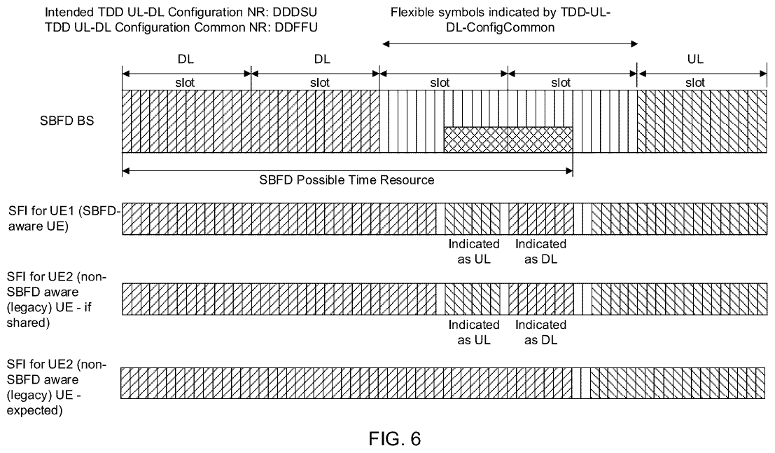

Referring now to FIG. 6, an example of one or more challenges to utilize an SFI for an SBFD link direction indication are illustrated according to one or more embodiments.

In an embodiment, no UE-specific SBFD configuration may be introduced.

In an example, regarding interaction of the SBFD symbol with legacy slot configuration signaling such as TDD-UL-DL-ConfigDedicated and SFI, the legacy behaviors may be maintained and cell-specific configuration may be prioritized over a UE-specific and a group-common signaling. In an example, legacy signaling may be used to explicitly indicate a link direction (e.g., transmit or receive) in an SBFD symbol. This may impact on legacy UEs behavior. For example, if SFI indicates UL on a SBFD symbol where SFI is received by both legacy and SBFD-aware UEs, this may lead to a behavior that the SBFD operation occurs in a legacy UL symbol and also has impacts on interpretation of SFI by legacy UEs as illustrated in FIG. 6.

Moreover, legacy signaling do not cover one or more DL symbols indicated by TDD-UL-DL-ConfigCommon and thus a new signaling may be required to explicitly indicate a link direction on an SBFD symbol on a cell-specific DL symbol. More importantly, one or more required slot formats (e.g., DDDDDDFUUUUUUF for 3^{rd} slot) may need to be added to predetermined table of slot formats associated with new entries and/or impacts on legacy UEs. In general, as shown in FIG. 6, when the SFI is shared between the SBFD-aware UE and the legacy UE, the legacy UE would not be able to interpret SFI correctly (as shown for UE2 if shared case in FIG. 6). If the SFI is separated between the SBFD-aware UE and the legacy UE, this may be considered as a new signaling. Similar problem may exist in TDD-UL-DL-ConfigDedicated for example, slot format (DDDDDDFUUUUUUF for 3^{rd} slot) is not supported in legacy TDD-UL-DL-ConfigDedicated. Based on drawbacks and impact on legacy UEs, one or more techniques may be utilized.

In an embodiment, legacy signaling such as TDD-UL-DL-ConfigDedicated and SFI may not be used to indicate a link direction on the SBFD symbol for the SBFD-aware UE.

When the SBFD-aware UE receives the TDD-UL-DL-ConfigDedicated, the UE may prioritize one or more cell-specific configurations including SBFD time/frequency configuration. The TDD-UL-DL-ConfigDedicated overrides only flexible symbols based on both TDD-UL-DL-ConfigCommon and cell specific SBFD configuration. A flexible symbol indicated by the cell specific SBFD configuration may be considered a SBFD symbol. In other words, the one or more SBFD symbols indicated by the cell specific SBFD configuration may not be overridden by the TDD-UL-DL-ConfigDedicated.

In an example, based on the legacy TDD-UL-DL-ConfigDedicated, in particular, when the one or more SBFD symbols are present only subset of symbols in a slot, the SBFD-aware UE may receive a TDD-UL-DL-ConfigDedicated for the slot with the one or more SBFD symbols. For example, if a SBFD-aware UE receives a slot format for the 3^{rd} slot in FIG. 6, existing TDD-UL-DL-ConfigDedicated may not properly indicate the slot format of (DDDDDDFUUUUUUF). In such a case, the SBFD-aware UE may expect either DL or flexible on such SBFD symbols i.e., TDD-UL-DL-ConfigDedicated may not indicate UL on symbols overlapping with SBFD symbols as the SBFD operation is expected to occur on non-UL symbols.

In an embodiment, TDD-UL-DL-ConfigDedicated overrides only one or more flexible symbols (i.e., non-DL, non-UL by TDD-UL-DL-ConfigCommon and non-SBFD symbols by a cell specific SFBD configuration). The SBFD-aware UE does not expect to receive TDD-UL-DL-ConfigDedicated indicating UL for a symbol that overlaps with a SBFD symbol indicated by the cell-specific SBFD configuration.

As SBFD operation is transparent to the legacy UEs, the TDD-UL-DL-ConfigDedicated signaling and/or behavior for the legacy UEs remain the same i.e., UL resource indicated by TDD-UL-DL-ConfigDedicated to a legacy UE does not overlap with cell-specific SBFD symbol.

In an example, regarding the SFI, legacy behavior may be maintained. In particular, as the SFI is a group-common signaling that may be shared between the legacy UEs and the SBFD-aware UEs, changes in the SFI may impact the legacy UEs. Moreover, legacy SFI behavior is as follows, where the SFI may not change a link direction indicated by a semi-static signaling.

For a set of symbols of a slot that are indicated as downlink and/or uplink by tdd-UL-DL-ConfigurationCommon, and/or tdd-UL-DL-ConfigurationDedicated, the UE does not expect to detect a DCI format 2_0 with an SFI-index field value indicating the set of symbols of the slot as uplink and/or downlink, respectively, or as flexible.

In an example, the SFI may not also change an SBFD symbol to a non-SBFD symbol. Similar to the TDD-UL-DL-ConfigDedicated, the SFI may indicate non-UL on one or more symbols overlapping with the one or more SBFD symbols.

In an embodiment, legacy behavior of the SFI may be maintained for both legacy and SBFD-aware UEs i.e., for a set of symbols of a slot that are indicated as downlink and/or uplink by tdd-UL-DL-ConfigurationCommon, and/or tdd-UL-DL-ConfigurationDedicated, the UE may not expect to detect a DCI format 2_0 with an SFI-index field value indicating the set of symbols of the slot as uplink and/or downlink, respectively, or as flexible.

In an embodiment, the SBFD-aware UE may not expect to receive the SFI indicating UL in a symbol that overlaps with the SBFD symbol indicated by the cell-specific SBFD configuration, e.g., a set of SBFD symbols by a cell-specific SBFD configuration, the SBFD-aware UE may not expect detect a DCI format 2_0 with an SFI-index field value indicating the set of symbols of the slot as uplink.

In an implementation, a SBFD-aware UE may expect a SBFD symbol may be indicated as downlink or flexible by legacy slot configuration signaling. However, a UL subband configured in the SBFD symbol may be used as uplink operation for the SBFD-aware UEs based on scheduling.

In an implementation, the SBFD symbol indicated by the cell-specific configuration on time and frequency location of the one or more SBFD subbands may not overlap with the legacy UL symbols indicated by intended TDD DL-UL configuration NR (e.g., intended TDD UL and/or DL configuration).

In an implementation, for cross link interference and fair coexistence, coordinated scheduling mechanism of information exchange, via Xn interface, of semi-static SBFD time/frequency configuration among neighboring base stations in co-channel and/or adjacent channel may be supported.

In an embodiment, no UE-specific SBFD configuration may be introduced.

In an embodiment, legacy signaling such as TDD-UL-DL-ConfigDedicated and/or SFI may not be used to indicate a link direction on a SBFD symbol for a SBFD-aware UE.

In an embodiment, TDD-UL-DL-ConfigDedicated overrides only one or more flexible symbols (i.e., non-DL, non-UL by TDD-UL-DL-ConfigCommon and non-SBFD symbols by a cell specific SFBD configuration). An SBFD-aware UE may not expect to receive TDD-UL-DL-ConfigDedicated indicating UL for a symbol that overlaps with a SBFD symbol indicated by the cell-specific SBFD configuration.

In an embodiment, legacy behavior of an SFI may be maintained for both legacy UEs and SBFD-aware UEs, e.g., for a set of symbols of a slot that are indicated as downlink and/or uplink by tdd-UL-DL-ConfigurationCommon, or tdd-UL-DL-ConfigurationDedicated, the UE may not expect to detect a DCI format 2_0 with an SFI-index field value indicating the set of symbols of the slot as uplink and/or downlink, respectively, or as flexible.

In an example, an SBFD-aware UE may not expect to receive an SFI indicating UL in a symbol that overlaps with a SBFD symbol indicated by the cell-specific SBFD configuration, e.g., a set of SBFD symbols by a cell-specific SBFD configuration, a SBFD-aware UE may not expect detect a DCI format 2_0 with an SFI-index field value indicating the set of symbols of the slot as uplink.

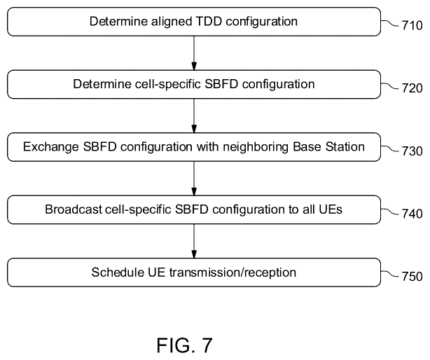

Referring now to FIG. 7, a flowchart illustrating an SBFD operation performed by a base station is shown according to one or more embodiments.

At 710, the base station may determine a cell-specific SBFD configuration. The cell-specific SBFD configuration may be indicative of one or more SBFD subbands in a TDD carrier.

At 720, the base station may exchange the cell-specific SBFD configuration with a neighboring base station using Xn signaling. In an example, sending the cell-specific SBFD configuration to the adjacent base station may include sending a semi-static SBFD time and frequency configuration to the adjacent base station. The semi-static SBFD time and frequency configuration includes one or more frequency locations of UL subbands.

At 730, the base station may transmit the cell-specific SBFD configuration to a plurality of UEs. In an example, the plurality of UEs are in a RRC connected mode.

At 740, the base station may schedule one or more SBFD enabled UEs of the plurality of UEs in the one or more SBFD subbands.

At 750, the base station may perform SBFD operation on the one or more SBFD subbands. In an example, performing SBFD operation may include transmitting one or more SBFD symbols to the one or more SBFD enabled UEs over the one or more SBFD subbands. In an example, performing SBFD operation may include receiving one or more SBFD symbols from the one or more SBFD enabled UEs over the one or more SBFD subbands.

In an example, one or more legacy signals may not be used to indicate a link direction on the one or more SBFD symbols. The one or more legacy signals may include at least one of: an SFI, or a TDD UL/DL dedicated configuration. The one or more flexible symbols may be non-DL and non-UL based on a TDD UL/DL common configuration and non-SBFD based on the cell-specific SBFD configuration. The one or more SBFD symbols may not overlap any legacy UL symbols.

In an example, the SBFD operation may facilitate transmitting and receiving data simultaneously between an SBFD-enabled UE and the base station using one or more frequency resources.

1. A method performed by a base station, the method comprising:
determining a cell-specific subband full duplex (SBFD) configuration indicative of one or more SBFD subbands in a time division duplex (TDD) carrier;
sending the cell-specific SBFD configuration to an adjacent base station using Xn signaling;
transmitting the cell-specific SBFD configuration to a plurality of user equipments (UEs);
scheduling one or more SBFD enabled UEs of the plurality of UEs in the one or more SBFD subbands; and
performing SBFD operation on the one or more SBFD subbands.

2. The method of claim 1, wherein performing SBFD operation includes transmitting one or more SBFD symbols to the one or more SBFD enabled UEs over the one or more SBFD subbands.

3. The method of claim 1, wherein performing SBFD operation includes receiving one or more SBFD symbols from the one or more SBFD enabled UEs over the one or more SBFD subbands.

4. The method of claim 1, wherein the plurality of UEs are in a radio resource control (RRC) connected mode.

5. The method of claim 2, wherein one or more legacy signals are not used to indicate a link direction on the one or more SBFD symbols.

6. The method of claim 5, wherein the one or more legacy signals include at least one of:
a slot format indicator (SFI), or
a TDD uplink (UL)/downlink (DL) dedicated configuration.

7. The method of claim 6, wherein the TDD UL/DL dedicated configuration overrides one or more flexible symbols.

8. The method of claim 7, wherein the one or more flexible symbols are non-DL and non-UL based on a TDD UL/DL common configuration and non-SBFD based on the cell-specific SBFD configuration.

9. The method of claim 6, wherein the one or more SBFD symbols do not overlap a legacy UL symbol.

10. The method of claim 1, wherein sending the cell-specific SBFD configuration to the adjacent base station comprises:
sending a semi-static SBFD time and frequency configuration to the adjacent base station.

11. The method of claim 10, wherein the semi-static SBFD time and frequency configuration includes one or more frequency locations of uplink (UL) subbands.

12. A base station, comprising:
a transceiver; and
a processor, wherein the transceiver and the processor are configured to:
determine a cell-specific subband full duplex (SBFD) configuration indicative of one or more SBFD subbands in a time division duplex (TDD) carrier,
send the cell-specific SBFD configuration to an adjacent base station using Xn signaling,
transmit the cell-specific SBFD configuration to a plurality of user equipments (UEs),
schedule one or more SBFD enabled UEs of the plurality of UEs in the one or more SBFD subbands, and
perform SBFD operation on the one or more SBFD subbands.

13. The base station of claim 12, wherein performing SBFD operation includes transmitting one or more SBFD symbols to the one or more SBFD enabled UEs over the one or more SBFD subbands.

14. The base station of claim 12, wherein performing SBFD operation includes receiving one or more SBFD symbols from the one or more SBFD enabled UEs over the one or more SBFD subbands.

15. The base station of claim 12, wherein the plurality of UEs are in a radio resource control (RRC) connected mode.

16. The base station of claim 13, wherein one or more legacy signals are not used to indicate a link direction on the one or more SBFD symbols.

17. The base station of claim 16, wherein the one or more legacy signals include at least one of:
a slot format indicator (SFI), or
a TDD uplink (UL)/downlink (DL) dedicated configuration.

18. The base station of claim 17, wherein the TDD UL/DL dedicated configuration overrides one or more flexible symbols.

19. The base station of claim 18, wherein the one or more flexible symbols are non-DL and non-UL based on a TDD UL/DL common configuration and non-SBFD based on the cell-specific SBFD configuration.

20. The base station of claim 17, wherein the one or more SBFD symbols do not overlap a legacy UL symbol.

21. The base station of claim 12, wherein sending the cell-specific SBFD configuration to the adjacent base station comprises:
sending a semi-static SBFD time and frequency configuration to the adjacent base station.

22. The base station of claim 21, wherein the semi-static SBFD time and frequency configuration includes one or more frequency locations of uplink (UL) subbands.
